(19) United States
(12) Patent Application Publication
(10) Pub. No.: US 2015/0109542 A1
(43) Pub. Date: Apr. 23, 2015

(54) TOUCH PANEL

(71) Applicant: Industrial Technology Research Institute, Hsinchu (TW)

(72) Inventors: Chung-Wen Wu, Hsinchu County (TW); Wei-Yi Lin, Taoyuan County (TW); Chyi-Ming Leu, Hsinchu County (TW); Chun-Wei Su, New Taipei City (TW)

(73) Assignee: Industrial Technology Research Institute, Hsinchu (TW)

(21) Appl. No.: 14/191,467

(22) Filed: Feb. 27, 2014

(30) Foreign Application Priority Data
Oct. 22, 2013 (TW) 102219677

(51) Int. Cl. G06F 3/041

(52) U.S. Cl. CPC G06F 3/041
USPC 349/12

(57) ABSTRACT

A touch panel is provided, which includes a poly(vinylidene fluoride) (PVDF) substrate and a touch electrode structure. The PVDF substrate has two opposite surfaces. The touch electrode structure is at least disposed on one of the surfaces.

### CROSS-REFERENCE TO RELATED APPLICATION

This application claims the priority benefit of Taiwan application no. 102219677, filed on Oct. 22, 2013. The entirety of the above-mentioned patent application is hereby incorporated by reference herein and made a part of this specification.

### TECHNICAL FIELD

The disclosure relates to a touch panel containing a poly(vinylidene fluoride) (PVDF) substrate.

### BACKGROUND

In recent years, a touch panel has become a main stream integrated in various kinds of electronic products. Therefore, finding a way of enhancing optical properties of a touch panel is an imperative issue.

A poly(vinylidene fluoride) (PVDF) of a fluoride resin is a material having excellent mechanical strength and can still maintain good strength under high temperatures and high pressures. In addition, PVDF has good toughness, great hardness, good abrasion resistance, outstanding properties of anti-UV rays and anti-aging against climates, and contains good chemical stability and thermal stability. However, when a composite material has low light transmittance and high color shift, a film having a poor optical property can easily be formed.

Furthermore, optical properties and costs of a polyethyleneterephthalate (PET) substrate and a polyimide (PI) substrate commonly used in this industry still need to improve. A touch element having a PVDF substrate has competitive advantages. This industry needs is a novel poly(vinylidene fluoride) (PVDF) composite material that has good optical properties.

### SUMMARY

One of the present embodiments comprises a touch panel. The touch panel includes a poly(vinylidene fluoride) (PVDF) substrate and a touch electrode structure. The touch electrode structure is disposed on at least one of the first surface and the second surface of the PVDF substrate.

Several exemplary embodiments accompanied with figures are described in detail below to further describe the disclosure in details.

### BRIEF DESCRIPTION OF DRAWINGS

FIG. 1 is a schematic view illustrating a touch panel according to a first exemplary embodiment of the disclosure.

FIG. 2 is a flow diagram illustrating steps for manufacturing a poly(vinylidene fluoride) (PVDF) substrate in the first exemplary embodiment.

FIG. 3A is a schematic view illustrating an example of a touch display panel in a second exemplary embodiment.

FIG. 3B is a schematic view illustrating another example of the touch display panel in the second exemplary embodiment.

FIG. 3C is a schematic view illustrating yet another example of the touch display panel in the second exemplary embodiment.

FIG. 4A is a schematic view illustrating a touch display panel according to a third exemplary embodiment of the disclosure.

FIG. 4B is a schematic view illustrating the touch display panel in another example of the third exemplary embodiment.

FIG. 5A is a schematic view illustrating a touch panel according to a fourth exemplary embodiment of the disclosure.

FIG. 5B is a schematic view illustrating the touch display panel in another example of the fourth exemplary embodiment.

FIG. 6A is a schematic view illustrating a touch display panel according to a fifth exemplary embodiment of the disclosure.

FIG. 6B is a schematic view illustrating the touch display panel in another example of the fifth exemplary embodiment.

FIG. 7 is a schematic view illustrating a touch display panel according to a sixth exemplary embodiment of the disclosure.

FIG. 8A is a schematic view illustrating a touch display panel according to a seventh exemplary embodiment of the disclosure.

FIG. 8B is a schematic view illustrating the touch display panel in another example of the seventh exemplary embodiment.

FIG. 8C is a schematic view illustrating the touch display panel in yet another example of the seventh exemplary embodiment.

FIG. 9A is a schematic view illustrating a touch display panel according to an eighth exemplary embodiment of the disclosure.

FIG. 9B is a schematic view illustrating the touch display panel in another example of the eighth exemplary embodiment.

FIG. 9C is a schematic view illustrating the touch display panel in yet another example of the eighth exemplary embodiment.

### DETAILED DESCRIPTION OF DISCLOSED EMBODIMENTS

With reference to the drawings attached, the disclosure will be described by means of the embodiments below. Nevertheless, the disclosure may be embodied in many different forms and should not be construed as limited to the embodiments set forth herein. In the drawings, for the purpose of clarity and specificity, the sizes and the relative sizes of each layer and region may not be illustrated in accurate proportion.

Unless specified in the disclosure, one element or layer being “on another element or layer” may represent the element or layer being directly located on another element or layer, or a middle element or layer may be disposed between the two elements. Moreover, directional terminology such as “above”, “below”, or other similar terms is used to describe the orientation of one element with respect to another (or a plurality of) elements in the Figure(s). Besides describing the spatial states shown in the Figures, this language used to depict the relative spatial relationships in the drawings may also describe the direction of the elements in use or in operation. For instance, when the elements in the drawings are turned upside down, the element depicted as being located or characterized “below” or “under” another element is then located or characterized as being “above” the other element.

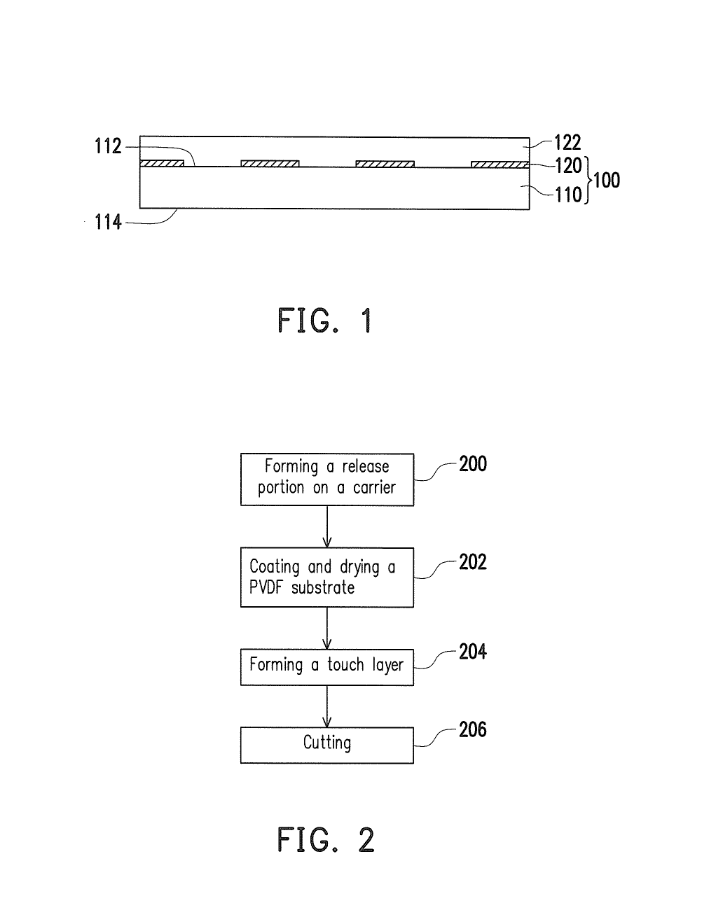

FIG. 1 is a schematic view illustrating a touch panel according to a first exemplary embodiment of the disclosure.

Referring to FIG. 1, a touch panel 100 of the first exemplary embodiment includes a poly(vinylidene fluoride) (PVDF) substrate 110 and a touch electrode structure 120. The PVDF substrate 110 has a first surface 112 and a second surface 114 opposite to each other. In the first exemplary embodiment, the touch electrode structure 120 is disposed on the first surface 112 of the PVDF substrate 110, but the disclosure is not limited herein. The touch electrode structure 120 can also be disposed on the second surface 114. In addition, a passivation layer 122 can also be disposed on the first surface 112 of the PVDF substrate 110 to cover and protect the touch electrode structure 120, but the disclosure is not limited herein. The passivation layer 122 can also be omitted or replaced by a functional film. The so-called functional film is, for example, a film containing functions such as a gas barrier (ex. side wall barrier, SWB), feedbacks, a color filter and a polarizing film.

A thickness of the PVDF substrate 110 is, for example, 0.1 μm to 350 μm, preferably 0.5 μm to 50 μm. A material of the PVDF substrate 110 includes PVDF and an inorganic nano modified material dispersed in PVDF, wherein the inorganic nano modified material is, for example, smectite clay, vermiculite, tubular kaolin, sericite, mica, synthetic mica, synthetic hydrotalcite, layered double hydroxide or a composition thereof. In the PVDF substrate 110, a weight ratio of PVDF and the inorganic nano modified material is, for example, 97:3 to 20:80, and haze thereof is smaller than or equal to 2. Therefore, the PVDF substrate 110 of an embodiment of the disclosure may be made of a modified PVDF.

The touch electrode structure 120 of an embodiment of the disclosure is a monolayer electrode structure, but the disclosure is not limited herein. The touch electrode structure 120 can be a double layer electrode structure or a bridge type electrode structure. Detailed descriptions are provided as follows. When an electric property of the touch electrode structure 120 varies due to sensing generated by touches of a user, sensing elements thereof can further acquire a correct position on which a user touches a panel via changes of voltages or capacitance.

The PVDF substrate 110 of the touch panel 100, for example, can be coated into sheets and output by an entire roll. The subsequent touch electrode structure 120 and the passivation layer 122 on the touch electrode structure 120 can be manufactured in a way of roll to roll (R2R), while the PVDF substrate 110 can also be manufactured in a way of sheet to sheet. An embodiment of sheet to sheet is as shown in FIG. 2.

In an example of the disclosure as shown in FIG. 2, in Step 200, a release portion is formed on a carrier. The carrier can be glass, polymethyl methacrylate (PMMA) or other materials having loading capability. A forming method of the release portion is, for example, to form a de-bonding layer or to form an adhesive area outside the release portion.

In Step 202, coating and drying the PVDF substrate are processed, wherein an area of the PVDF substrate is larger than or equal to an area of the release portion. In Step 204, a touch layer is formed on the PVDF substrate in the release portion.

With a mechanism that adhesion force between the release portion and the carrier is smaller than adhesion force between the PVDF substrate and the carrier, the touching layer is de-bonded and removed via a cutting process of Step 206. However, the structure of the disclosure is not limited to the product implemented in the aforesaid manufacturing process.

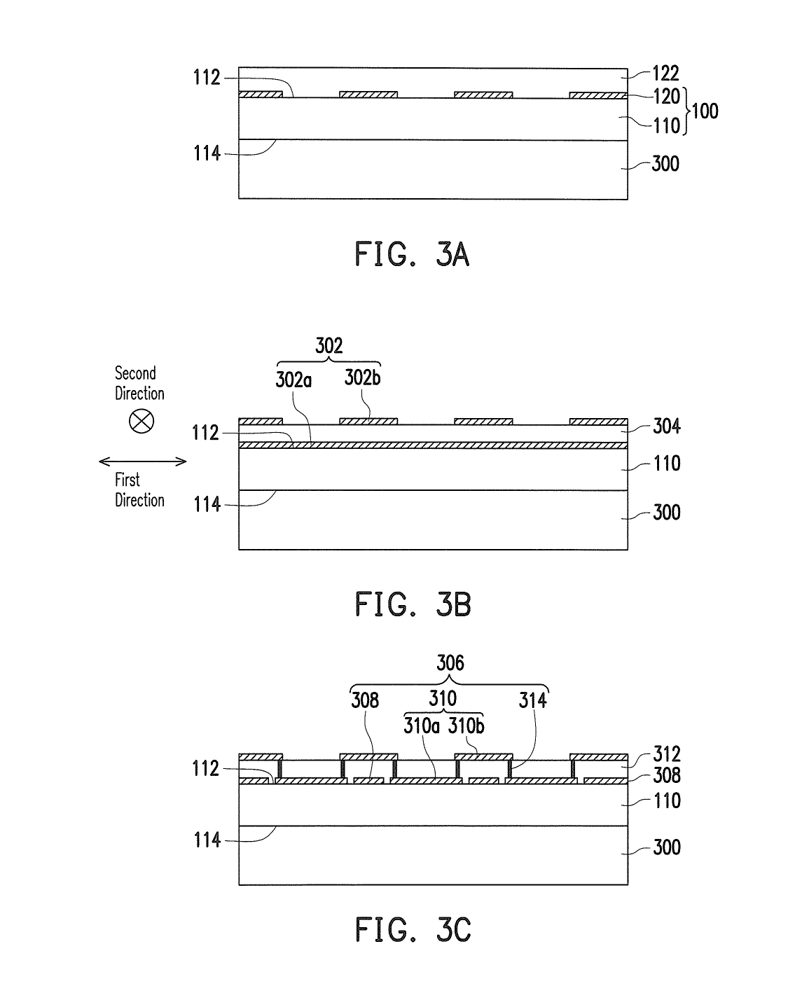

FIG. 3A, FIG. 3B and FIG. 3C are schematic views respectively illustrating three examples of a touch display panel according to of a second exemplary embodiment of the disclosure.

In FIG. 3A, a touch panel 100 of the first exemplary embodiment and a display 300 are provided. The display 300 is disposed on the second surface 114 of the PVDF substrate 110. The touch panel 100 and the display 300 together form a touch display panel. The display 300 is, for example, a rigid display, a flexible display or an organic light-emitting diode (OLED) display. However, the disclosure is not limited herein. The display 300 may be arranged on the touch electrode structure 120 and may be suitable for the following exemplary embodiments.

When a user uses this type of touch display panel, the first surface 112 may be a surface facing the user. The second surface 114 is opposite to the first surface 112. The PVDF substrate 110 is disposed on the display 300 via the second surface 114.

The touch electrode structure 120 of the second exemplary embodiment may further be other types. As shown in FIG. 3B, a double layer electrode structure 302 includes a plurality of first electrodes 302a, a plurality of second electrodes 302b and an insulating layer 304 therebetween. The plurality of first electrodes 302a are formed on the PVDF substrate 110 and arranged without overlapping with each other along a first direction. The insulating layer 304 is formed on the PVDF substrate 110 and covers the plurality of first electrodes 302a. The plurality of second electrodes 302b are formed on the insulating layer 304 and arranged without overlapping with each other along a second direction. In an embodiment, the first direction can be perpendicular to the second direction.

In the present exemplary embodiment, the second electrodes 302b of FIG. 3B may be disposed on the second surface 114 of the PVDF substrate 110, such that the PVDF substrate 110 becomes an insulating layer between the first electrodes 302a and the second electrodes 302b, and therefore is able to replace the functions of the insulating layer 304.

The touch electrode structure 120 of the second exemplary embodiment may be replaced with a bridge type electrode structure 306 as shown in FIG. 3C. The bridge type electrode structure 306 of FIG. 3C includes a plurality of first electrodes 308, a plurality of second electrodes 310 and an insulating layer 312 therebetween. The second electrodes 310 is composed of lower electrode layers 310a and upper electrode layers 310b connected by bridge conductive wires 314. Both the first electrodes 308 and the lower electrode layers 310a disposed on the first surface 112 of the PVDF substrate 110 are not in contact with each other. The upper electrode layer 310b disposed on the insulating layer 312 are electrically connected to the lower electrode layer 310a via the bridge conductive wires 314.

The touch electrode structure of the first and the second exemplary embodiments can be, for example, a transparent electrode material, such as indium tin oxide (ITO); or nano-silver electrodes, metal mesh electrodes, or electrodes designed for a touch function.

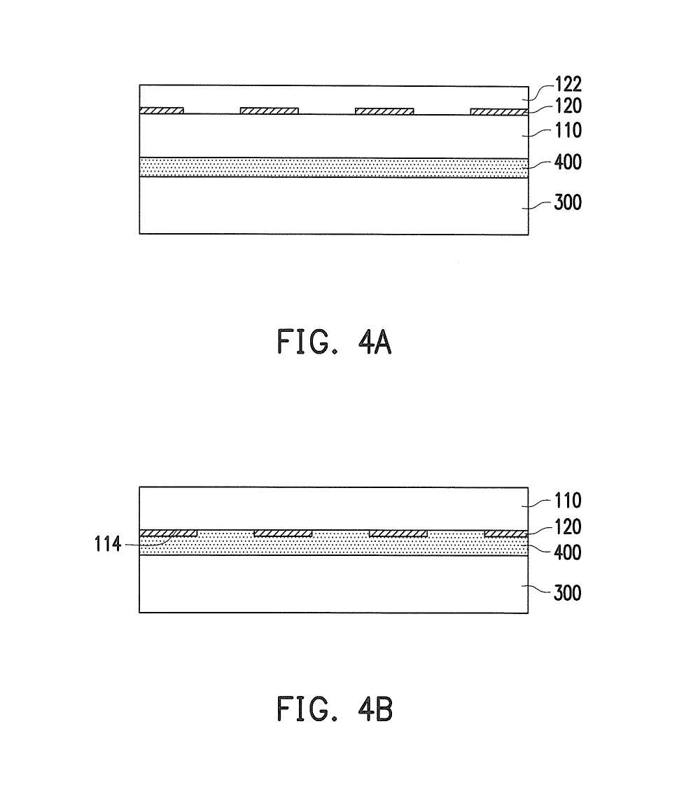

FIG. 4A is a schematic view illustrating a touch display panel according to a third exemplary embodiment of the disclosure. Compared to the second exemplary embodiment, in addition to a first adhesion layer 400 further included in a touch display panel of FIG. 4A, other elements are the same as those shown in the touch display panel of FIG. 3A. Thus, same reference numerals are adopted to represent the same elements, and descriptions with regard to the same elements are omitted herein. The first adhesion layer 400 is disposed between the display 300 and the PVDF substrate 110. A material thereof is, for example, a pressure sensitive adhesive (PSA), an optically clear adhesive (OCA), a photosensitive hydrogel (a UV glue), optical clear resins (OCR) and the like. A function of the first adhesion layer 400 is primarily to increase adhesion force between the display 300 and the PVDF substrate 110. In the present exemplary embodiment, the touch electrode structure 120 is a monolayer electrode structure, but the disclosure is not limited herein. The touch electrode structure 120 may be a double layer electrode structure as shown in FIG. 3B or a bridge type electrode structure as shown in FIG. 3C.

FIG. 4B is a schematic view illustrating the touch display panel in another example of the third exemplary embodiment. The first adhesion layer 400 of FIG. 4B is disposed between the display 300 and the touch electrode structure 120. The touch electrode structure 120 may be disposed on the second surface 114 of the PVDF substrate 110. The touch electrode structure 120 may be replaced with the double layer electrode structure of FIG. 3B or the bridge type electrode structure of FIG. 3C.

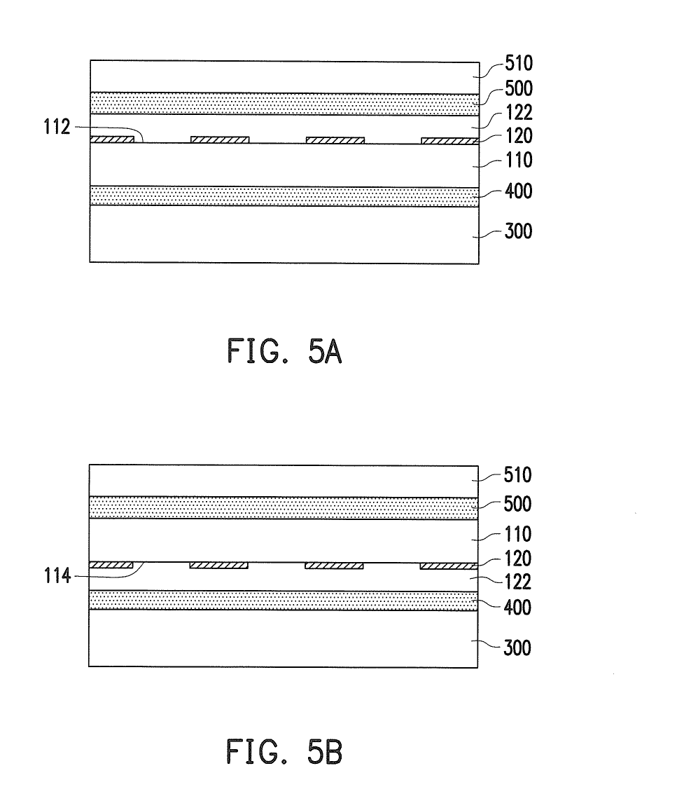

FIG. 5A is a schematic view illustrating a touch panel according to a fourth exemplary embodiment of the disclosure. Compared to the third exemplary embodiment, in addition to a second adhesion layer 500 and a cover 510 further included in the touch display panel of FIG. 5A, other elements thereof are the same as those shown in the touch display panel of FIG. 4A. Thus, same reference numerals are adopted to represent the same elements, and descriptions with regard to the same elements are omitted herein.

Referring to FIG. 5A, the second adhesion layer 500 is disposed between the passivation layer 122 and the cover 510. A material of the second adhesion layer 500 is, for example, a pressure sensitive adhesive (PSA), an optically clear adhesive (OCA), a photosensitive hydrogel (a UV glue), optical clear resins (OCR) and the like, and a function thereof is primarily to increase adhesion force between the passivation layer 122 and the cover 510. The cover 510 is, for example, a material such as glass, polymethyl methacrylate (PMMA), or polycarbonate (PC). A function of the cover 510 is primarily to protect the touch electrode structure 120 covered by the passivation layer 122 from being damaged when a user uses a touching surface. On the other hand, if the configured second adhesion layer 500 does not affect conductivity characteristics of the touch electrode structure 120, the passivation layer 122 of FIG. 5A may be omitted, such that the second adhesion layer 500 is disposed between the cover 510 and the touch electrode structure 120, and the same effects of preventing the touch electrode structure 120 from being damaged can still be achieved.

FIG. 5B is a schematic view illustrating the touch display panel in another example of the fourth exemplary embodiment. The primary difference between FIG. 5B and FIG. 5A lies in that arrangements of the PVDF substrate 110 and the passivation layer 122 are swapped. Therefore, the touch electrode structure 120 may be disposed on the second surface 114 of the PVDF substrate 110. Referring to the structure as shown in FIG. 4B, the passivation layer 122 in the touch display panel of FIG. 4B may be omitted, such that the touch electrode structure 120 is in contact with the first adhesion layer 400.

Other than adopting the configured monolayer electrode structure as shown in FIG. 3A, the double layer electrode structure of FIG. 3B or the bridge type electrode structure of FIG. 3C may be configured for the touch electrode structure 120 of the third exemplary embodiment and the fourth exemplary embodiment.

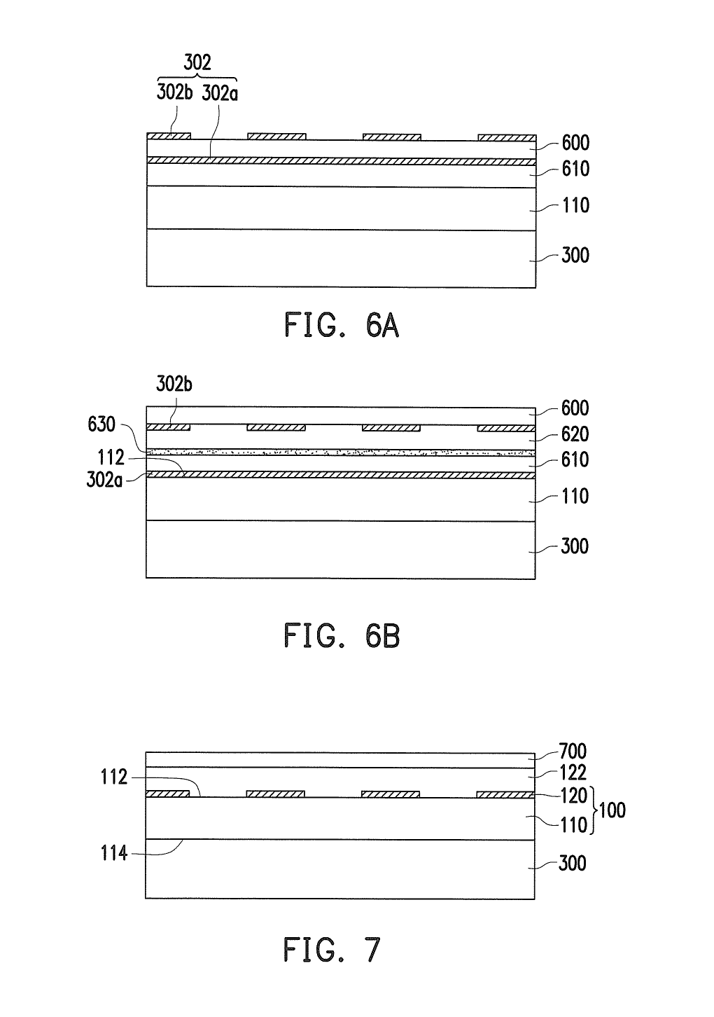

FIGS. 6A and 6B are schematic views illustrating two types of touch display panels according to a fifth exemplary embodiment of the disclosure. Compared to FIG. 3B of the second exemplary embodiment, in addition to a PVDF layer 600 and a buffer layer 610 further included in a touch display panel of FIGS. 6A to 6B, other elements thereof are similar to those shown in the touch display panel of the second exemplary embodiment. Thus, same reference numerals are adopted to represent the same elements, and descriptions with regard to the same elements are omitted herein.

Referring to FIG. 6A first, the PVDF layer 600 of the touch display panel is disposed between the plurality of first electrodes 302a and the plurality of second electrodes 302b as an insulating layer between the plurality of first electrodes 302a and the plurality of second electrodes 302b, and a material thereof may be made of modified PVDF as the one made for the PVDF substrate 110. In the present exemplary embodiment, a method for processing the PVDF layer 600 may be coating, and the PVDF layer 600 is not in contact with the PVDF substrate 110. The buffer layer 610 may be formed between the PVDF layer 600 and the PVDF substrate 110, and a material of the buffer layer 610 can be SiOₓ or SiNₓ or SiOₓN_{y}, etc. A thickness of the PVDF layer 600 is, for example, 0.1 μm to 200 μm, and preferably 0.5 μm to 5 μm. Since a dielectric coefficient (k) of a PVDF material itself is approximately 7, a touch panel has tactile feedback characteristics if the PVDF layer 600 is disposed in the touch panel. Using time-division driving between touch and feedback, a tactile feedback element may provide effects of both touch and feedback. Induced charges generating by tactile feedback elements through variable driving waveform may provide different contact feeling of users. The higher dielectric coefficient of an insulating layer of a touch feedback element, the lower driving voltages of tactile feedback requirement. Compared to a dielectric coefficient of a common polymer material being approximately 3, the dielectric coefficient of PVDF is approximately 7. When the PVDF layer 600 is disposed in a touch panel, the touch panel displays enhanced feedback effects.

Table 1 below illustrates testing comparisons between using a PVDF layer of the present exemplary embodiment and polyimide (PI).

Testing Condition: Square wave @100 HZ

TABLE 1

| | Subject | | | | | | | |
|---|---|---|---|---|---|---|---|---|
| | 1 | 2 | 3 | 4 | 5 | 6 | 7 | |
| PI | 70 V | 70 V | 200 V | 100 V | 140 V | 70 V | 140 V | Average |
| (4 μm) | | | | | | | | Voltage |
| k = 2~3 | | | | | | | | Difference |
| PVDF | 50 V | 50 V | 100 V | 70 V | 100 V | 70 V | 90 V | |
| (4 μm) | | | | | | | | |
| k = 7 | | | | | | | | |
| Voltage | 20 V | 20 V | 100 V | 30 V | 40 V | 0 V | 50 V | 37 V |
| Drop | | | | | | | | |

From Table 1, it can be understood that a dielectric coefficient of an insulating layer has influences on tactile senses as only one subject cannot determine differences. An average voltage difference of the subjects is 37V, wherein a voltage difference of one of the subjects reaches 100V. The experimental results prove that a touch panel displays enhanced feedback effects when a PVDF substrate and/or layer are disposed in the touch panel.

FIG. 6B is a schematic view illustrating the touch display panel in another example of the fifth exemplary embodiment. Arrangements of the first electrodes 302a in FIG. 6B and FIG. 6A are different, as the first electrodes 302a are disposed on the first surface 112 of the PVDF substrate 110, and the buffer layer 610 covering on the first electrodes 302a may be configured as a passivation layer. The plurality of second electrodes 302b are disposed below the PVDF layer 600, and passivation layer 620 may be disposed between the PVDF layer 600 and the buffer layer 610. In addition, an adhesive layer 630 may be configured between the buffer layer 610 and the passivation layer 620 for lamination. On the other hand, the buffer layer 610 and the passivation layer 620 in FIG. 6B may further be omitted as long as the configured adhesive layer 630 does not damage the first electrodes 302a and the second electrodes 302b, such that the adhesive layer 630 is disposed between the first electrodes 302a on the PVDF substrate 110 and the PVDF layer 600, and covers the second electrodes 302b.

The first adhesion layer of the third exemplary embodiment and/or the second adhesion layer and the cover of the fourth exemplary embodiment may be disposed in the touch display panel of the fifth exemplary embodiment, and therefore it is not reiterated herein.

FIG. 7 is a schematic view illustrating a touch display panel according to a sixth exemplary embodiment of the disclosure. Compared to the second exemplary embodiment, in addition to one more layer of a PVDF layer 700 included in a touch display panel of FIG. 7, other elements are the same as those shown in the touch display panel of FIG. 3A. Thus, same reference numerals are adopted to represent the same elements, and descriptions with regard to the same elements are omitted herein. PVDF has good anti-reflective characteristics and anti-ultraviolet capability, and therefore, when the PVDF layer 700 is configured as a hard coat for the touch panel 100, it also contains functions of anti-reflectivity and anti-UV and prolongs a life time for a product. The PVDF layer 700 may be formed on the touch panel 100 by employing a coating technology or a laminating technology. The touch electrode structure 120 of the present exemplary embodiment is a monolayer electrode structure, but it may be a double layer electrode structure as shown in FIG. 3B or a bridge type electrode structure as shown in FIG. 3C.

In the aforesaid exemplary embodiments, the PVDF substrate 100 has a good light transmittance property and low color shift. In addition, in comparison with other types of touch panels listed in Table 2 below, a thickness of the PVDF substrate is comparatively thinner. Consequently, an integration of a PVDF substrate and a flexible display enhances light transmittance of a touch panel, such that color shift is close to 0 and the touch panel further contains improved optical characteristics. Moreover, in the aforesaid fourth and fifth exemplary embodiments, since a PVDF layer is further disposed in the touch panel, tactile feedback characteristics of the touch panel is enhanced and electrical efficiency of the touch panel is improved.

TABLE 2

| | | Transmittance | | Color | | | | | |
|---|---|---|---|---|---|---|---|---|---|
| | Thickness | (T %) | | shift | | | E* | Cost | Temp.* |
| | (μm) | Average | 550 nm | b* | N* | Haze | (MPa) | (NT/m²) | (° C.) |
| PI | 15 | ≧89 | ≧89 | <2 | ~1.6 | <1 | 2000 | 1000 | <250 |
| PVDF of | 15~50 | ≧93 | ≧93 | <1 | 1.4~1.45 | <1 | 1300~2000 | 70 | ~160 |
| the | | | | | | | | | |
| disclosure | | | | | | | | | |
| PET | 100 | ≧92 | ≧92 | <1 | 1.57 | <1 | 800 | 100 | 150 |

*N represents refractive index, E represents Young's modulus, and Temp. represents process temperature tolerance.

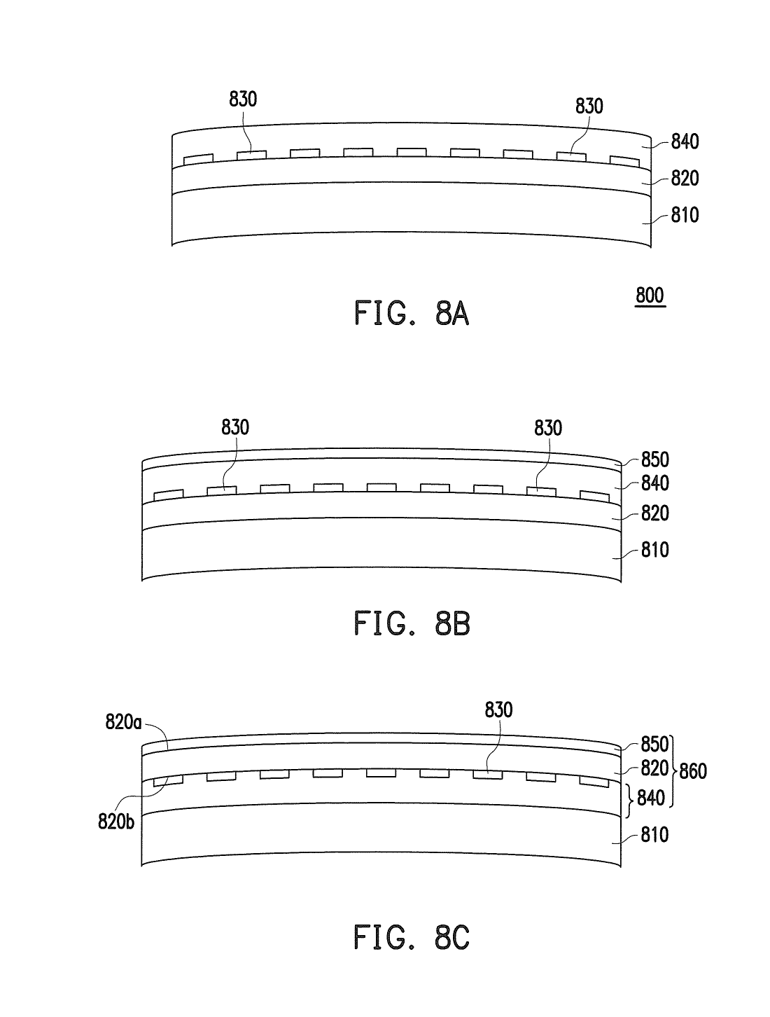

FIG. 8A is a schematic view illustrating a touch display panel according to a seventh exemplary embodiment of the disclosure.

Referring to FIG. 8A, a touch display panel 800 includes a flexible display 810, a PVDF substrate 820 and a touch electrode structure 830, wherein a passivation layer 840 is disposed on the touch electrode structure 830. Since components of each of the aforesaid exemplary embodiments can be correspondingly applied in the present exemplary embodiment, and therefore they are not reiterated herein.

FIG. 8B is a schematic view of a touch display panel in another example of the seventh exemplary embodiment. A different between FIG. 8B and FIG. 8A lies in that one more layer of a hard coat 850 in FIG. 8B is further included, while other components of FIG. 8B are as the same as those of the touch display panel in FIG. 8A. Thus, same reference numerals are adopted to represent the same elements, and descriptions with regard to the same elements are omitted herein. A method for forming the hard coat 850 may be a coating method such as a spin coat, a screen printing or a die coat, or the hard coat 850 may be manufactured in a deposition process. A material of the hard coat 850 may be an organic material, an inorganic material or a hybrid organic-inorganic material. On the other hand, if the configured hard coat 850 does not affect conductivity characteristics of the touch electrode structure 830, the passivation layer 840 of FIG. 8B may be omitted, such that the hard coat 850 is disposed on the touch electrode structure 830 and the same effects of preventing the touch electrode structure 830 from being damaged can still be achieved.

FIG. 8C is a schematic view illustrating the touch display panel in another exemplary embodiment of the seventh exemplary embodiment. A different between FIG. 8C and FIG. 8B lies in that arrangements of the PVDF substrate 820 and the passivation layer 840 are swapped, while other elements in FIG. 8C are as the same as those shown in the touch display panel of FIG. 8B. Thus, same reference numerals are adopted to represent the same elements. The touch display panel of FIG. 8C may be manufactured in a roll to roll (R2R) process by forming the hard coat 850 on one surface 820a of the PVDF substrate 820 and the touch electrode structure 830 on the other surface 820b of the PVDF substrate 820. In addition, the touch display panel of FIG. 8C may be manufactured in a Flex-UP (a Flexible Universal Plane techniques) process. Namely, a release portion is first formed on a carrier using a process similar to that of FIG. 2, and the hard coat 850 is then formed. The PVDF substrate 820 is coated on the hard coat 850 before manufacturing the touch electrode structure 830 and the passivation layer 840 on the PVDF substrate 820. A cutting process is then performed to remove a flexible PVDF substrate touch device 860 containing the hard coat 850. The flexible PVDF substrate touch device 860 may be removed first and then be laminated with the flexible display 810, or it may be removed with a cutting process after being laminated with the flexible display 810. On the other hand, the passivation layer 840 may further be omitted if a configured lamination material does not affect conductivity characteristics of the touch electrode structure 830.

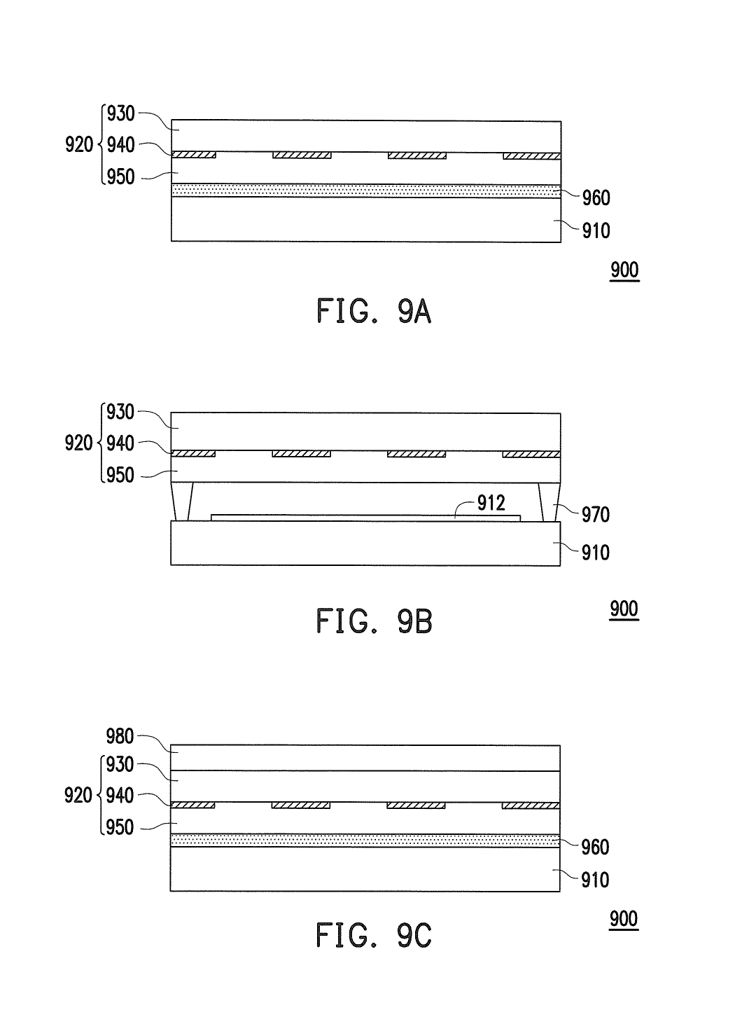

FIG. 9A is a schematic view illustrating a touch display panel according to an eighth exemplary embodiment of the disclosure.

Referring to FIG. 9A, a touch display panel 900 includes a display, such as an organic light-emitting diode (OLED) display 910 and a functional touch panel 920, wherein the functional touch panel 920 is disposed on the OLED display 910 and includes a PVDF substrate 930, a touch electrode structure 940 and a layer of functional film 950. In the present exemplary embodiment, the functional touch panel 920 refers to a touch film at least integrating gas barrier and a touch function, and is used in a protective film of a flexible functional touch film of a display device package. The functional film 950 in the functional touch panel 920 may further contain functions such as side wall barrier (SWB), feedback, a color filter, and a polarizing film based on needs. The functional film 950 in FIG. 9A is manufactured after the touch electrode structure 940 is formed, but the disclosure is not limited herein. Namely, the functional film 950 may be manufactured before the touch electrode structure 940 is formed; or the functional film 950 may be disposed between the PVDF substrate 930 and the touch electrode structure 940 as an insulating layer, such as the double layer electrode structure of FIG. 3B, and therefore it is not reiterated herein.

In addition, in the present exemplary embodiment, a first adhesion layer 960 may further be disposed between the OLED display 910 and the functional touch panel 920. The first adhesion layer 960 is similar to the first adhesion layer 400 of the third exemplary embodiment, and may increase adhesion force between the OLED display 910 and the functional touch panel 920. The touch electrode structure 940 of the present exemplary embodiment is a monolayer electrode structure, but it may be a double layer electrode structure as shown in FIG. 3B or a bridge type electrode structure as shown in FIG. 3C.

FIG. 9B is a schematic view illustrating the touch display panel in another example of the eighth exemplary embodiment. Reference numerals used in FIG. 9B are the same as those used in FIG. 9A for representing the same elements.

In FIG. 9B, a functional film 950, a touch electrode structure 940 and a PVDF substrate 930 are respectively disposed on the OLED display 910. Therefore, the functional film 950 is manufactured after the touch electrode structure 940 is formed. In addition, the OLED display 910 at least includes an OLED display element 912 having an organic material and a side wall barrier (SWB) structure 970 surrounding the OLED display element 912, wherein a configuration of the SWB 970 is, for example, an inverted trapezoid, but the disclosure is not limited herein. A material of the SWB 970 is, for example, an organic material, an inorganic material, or a hybrid organic-inorganic material, or an organic-inorganic stacking, so as to achieve, for example, at least Water Vapor Transmission Rate (WVTR)≦10⁻¹ g/m²-day. Therefore, the SWB 970 may prevent the OLED display 910 from degradation due to moisture and oxygen penetrating into the touch display panel 900. The SWB structure of the present exemplary embodiment is disposed around the OLED display element, but an application of the OLED display element is not limited in the disclosure.

FIG. 9C is a schematic view illustrating the touch display panel in another exemplary embodiment of the eighth exemplary embodiment. A different between FIG. 9C and FIG. 9A lies in that one more layer of a hard coat 980 is arranged, while other elements in FIG. 9C are as the same as those shown in the touch display panel 900 of FIG. 9A. Thus, same reference numerals are adopted to represent the same elements. The hard coat 980 is disposed on the PVDF substrate 930, and a material thereof is, for example, epoxy resin, or a hardening layer material having acrylic as a basis. A function of the hard coat 980 is primarily to protect the PVDF substrate 930 down below so as to increase scratching endurance of the functional touch panel 920.

In the present exemplary embodiment, the PVDF 930 and the OLED display 910 are integrated to improve light transmittance of the touch display panel 900, such that color shift thereof is close to 0. Moreover, a hydrophobic property of PVDF may be used to prevent the OLED display 910 from degradation due to moisture and oxygen.

The PVDF of an embodiment of the disclosure contains inorganic nano modified material and smaller crystallization sizes, and therefore contains comparatively higher light transmittance and more softness. The PVDF substrate of an embodiment of the disclosure can be integrated with various types of flexible and rigid display so as to enhance light transmittance of a touch element and reduce color shift of the touch element. Furthermore, a PVDF layer having high dielectric coefficient can be disposed between the PVDF substrate and a touch layer. Therefore, this PVDF layer can also be a dielectric layer in a touch panel to further reduce driving voltages of tactile feedback in order to improve electrical efficiency of the touch panel.

Although the disclosure has been disclosed with reference to the aforesaid embodiments, they are not intended to limit the disclosure. It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A touch panel, comprising:
a poly(vinylidene fluoride) (PVDF) substrate, having a first surface and a second surface opposite to each other; and
a touch electrode structure, disposed at least on one of the first surface and the second surface.

2. The touch panel as claimed in claim 1, wherein the touch electrode structure is disposed between the PVDF substrate and a display, and the display comprises a rigid display or a flexible display.

3. The touch panel as claimed in claim 2, further comprising a hard coat covering one of the surfaces of the PVDF substrate.

4. The touch panel as claimed in claim 2, further comprising a functional film disposed between the display and the PVDF substrate or disposed on the PVDF substrate relative to the display.

5. The touch panel as claimed in claim 4, wherein the touch electrode structure is disposed on the functional film, on both sides of the functional film or between the PVDF substrate and the functional film.

6. The touch panel as claimed in claim 4 further comprising a gas barrier disposed around display elements of the display.

7. The touch panel as claimed in claim 1, further comprising a first adhesion layer disposed between the touch electrode structure and a display.

8. The touch panel as claimed in claim 1, wherein the touch electrode structure is disposed on the first surface of the PVDF substrate and a display is disposed on the second surface of the PVDF substrate.

9. The touch panel as claimed in claim 8, further comprising a first adhesion layer disposed between the display and the PVDF substrate.

10. The touch panel as claimed in claim 1, wherein the touch electrode structure comprises a monolayer electrode structure, a double layer electrode structure or a bridge type electrode structure.

11. The touch panel as claimed in claim 1, further comprising a second adhesion layer disposed between the touch electrode structure and a cover.

12. The touch panel as claimed in claim 1, further comprising a second adhesion layer disposed between the PVDF substrate and a cover.

13. The touch panel as claimed in claim 1, further comprising a hard coat disposed on the touch electrode structure.

14. The touch panel as claimed in claim 1, further comprising a passivation layer disposed on the touch electrode structure.

15. The touch panel as claimed in claim 14, further comprising a hard coat covering a surface of the passivation layer.

16. The touch panel as claimed in claim 14, further comprising a PVDF layer covering a surface of the passivation layer.

17. The touch panel as claimed in claim 1, further comprising a PVDF layer disposed on the PVDF substrate, the PVDF layer is isolated to the PVDF substrate.

18. The touch panel as claimed in claim 17, further comprising:
an adhesive layer disposed between the PVDF layer and the PVDF substrate; and
the touch electrode structure comprising a double layer electrode structure, respectively disposed between the PVDF layer and the adhesive layer and between the adhesive layer and the PVDF substrate.

19. The touch panel as claimed in claim 18, further comprising a passivation layer disposed between the adhesive layer and the PVDF layer, and covering the touch electrode structure.

20. The touch panel as claimed in claim 17, further comprising a buffer layer disposed between the PVDF layer and the PVDF substrate.

21. The touch panel as claimed in claim 1, further comprising:
a PVDF layer, disposed on the PVDF substrate;
a buffer layer disposed between the PVDF layer and the PVDF substrate to separate the PVDF layer and the PVDF substrate; and
the touch electrode structure comprising a double layer electrode structure, respectively disposed on upper and lower surfaces of the PVDF layer.
